(19) United States
(12) Patent Application Publication
(10) Pub. No.: US 2010/0255973 A1
(43) Pub. Date: Oct. 7, 2010

(54) METHOD OF MAKING AND INSPECTING BAGS

(76) Inventor: Eric DeSmedt, Green Bay, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/599,952

(22) PCT Filed: May 14, 2008
(86) PCT No.: PCT/US08/06137

§ 371 Date: Nov. 12, 2009

Related U.S. Application Data
(60) Provisional application No. 60/930,313, filed on May 15, 2007.

(51) Int. Cl. B31B 1/14

(52) U.S. Cl. 493/227

(57) ABSTRACT

A system for inspecting individual bags during stacking facilitates defect-free stacking of the bags for subsequent use with automated filling equipment. The present system includes a camera inspection system which is operated to inspect a predetermined portion of each bag, such as a header portion thereof, preferably in conjunction with stacking of each bag on an associated wicket. The present system is particularly suited for identifying bags having a folded corner and/or determining that only one of a pair of holes of a hag has been placed on the associated wicket.

### TECHNICAL FIELD

The present invention relates generally to a method of making and inspecting bags and like packages from heat-sealable, thermoplastic web material, and more particularly to a system for making and inspecting bags, which may include a pair of holes for stacking on an associated wicket, whereby each bag is electronically analyzed during formation to detect defects, including irregularities which prevent efficient stacking of the bags on an associated wicket.

### BACKGROUND OF THE INVENTION

Bags and like packages made from heat-sealable, thermoplastic web material are well-known in the prior art, in view of their cost-effective manufacture, and highly versatile use. For some applications, it is desirable that bags of this nature include a lip or header portion in which a pair of holes are formed, which holes facilitate stacking of bags on an associated wicket. Stacking of bags in this fashion facilitate their convenient handling after manufacture, and permit the bags to be efficiently used in conjunction with associated automatic packaging equipment.

As will be appreciated, bags which are not properly stacked on an associated wicket may undesirably detract from efficient use with associated automated packaging equipment. Improper stacking can result if one or more of the stacking holes does not align with the associated stacking pins (a so-called “one holer”), or if a portion of a bag is folded, such as a leading edge corner, undesirably resulting in a so-called “dog ear”.

A printing irregularity can also create a bag which is unacceptable, and again, removing the bag during automated packaging can detract from desired efficiency.

While visual inspection of bags by operators is typically performed, such inspection naturally depends upon the skill level and alertness of the operator, and irregularly stacked or formed bags can sometimes be missed. The present invention is directed to a method of making and inspecting bags, particularly those having a pair of holes for stacking on associated wickets, which facilitates efficient bag formation and stacking, while avoiding introduction of an improperly positioned or formed bag into an automated packaging operation.

### SUMMARY OF THE INVENTION

In accordance with the present invention, a method of making and inspecting bags contemplates use of generally conventional bag-making equipment, with the present system contemplating the provision of a camera for electronically inspecting a portion of each of the bags attendant to formation, and prior to or in conjunction with any stacking on associated wickets, as may be effected.

In accordance with the present method, a web of film material is provided, typically in the form of heat-sealable, thermoplastic film. The web of film is folded, and may be optionally formed to include a bottom gusset.

Subsequent to folding of the web of material, a series of bags are formed joined together at edge portions thereof. This is effected by forming periodic seals in the web of material.

In the illustrated embodiment, the web of material is folded to form a generally J-shaped cross-section, thus forming each bag with a lip or header portion. In order to facilitate stacking of bags on an associated wicket for efficient handling after manufacture, and for use with automated packaging equipment, a pair of holes is formed in the header portion of each of the bags.

The web of material is cut at the seals formed in the web to thereby form individual ones of the bags. Typically, the bags are thereafter picked-up and stacked, with a wicket mill with two or more sets of vacuum-loaded arms picking up each bag from associated belts.

In accordance with the present invention, the time at which each bag is inspected depends upon the type of defect which is sought to be detected. For example, dog-eared bags can be detected as of the moment that the draw is ongoing, until the bag is on the associated stack. In distinction, the ideal moment at which to detect a “one-holer” is the moment that the lip or header portion of the bag goes over the associated wicket pins, since it is only at that moment that it can be determined if the holes are properly aligned with the pins for placement of the bag on the wicket. It is, of course, possible to detect hole position prior to movement of each bag over the associated wicket pins, and then make a mathematical tracking calculation of the path of the holes in order to calculate the “landing position” of the bag. Operation in this manner depends upon the bag remaining in place on the vacuum-loaded arms after detection of the hole positions.

As noted, features other than the positioning and configuration of the stacking holes, such as package printing, can also be inspected and evaluated in accordance with the system of the present invention.

The camera of the present system electronically inspects the desired portion of each of the bags, with signals provided to the camera in cooperation with the cutting step, to form an electronic image of the desired portion of each of the bags. This electronic image is electronically analyzed to evaluate conformance of the image with predetermined parameters, such as hole placement, printing placement, etc.

Depending upon the corrective action to be effected, the present system can be operated so as to divert any one of the bags which creates an electronic image that does not conform to the desired predetermined parameters. Such bags can then be recycled or otherwise handled.

Measurements taken by the camera of the present system are analyzed by a sequence of logic functions in order to determine whether the particular bag is accepted or rejected. Typical processing time for such analyses is sufficiently small as to permit inspection of each bag within the cycle time of the associated bag-making and wicket stacking machinery.

Other features and advantages of the present invention will become readily apparent from the following detailed description, the accompanying drawings, and the appended claims.

### BRIEF DESCRIPTION OF THE DRAWINGS

FIG. 1 is a diagrammatic, perspective view illustrating stacking of bags, each having a pair of wicket holes, on associated stacking pins;

FIG. 2 is a diagrammatic, perspective view of one of the bags shown in FIG. 1, wherein a corner portion of the bag has been inadvertently folded to form a “dog ear”;

FIG. 3 is a diagrammatic, perspective view of a wicket mill which operates to stack the individual bags on an associated pair of stacking pins;

FIG. 4 is a front elevational view, taken generally along lines 4-4 of FIG. 3, illustrating the wicket mill, and associated inspection camera operated in accordance with the present invention; and

FIGS. 5a-f illustrate camera-captured video images of bags being inspected in accordance with the present invention, including images which illustrate defects which can be identified by the inspection system of the present invention.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

The present invention relates to a method to detect, and eventually remove, non-conforming bags during the process of bag-making, including stacking of the bags for eventual use of stacks of the bags for automated insertion of articles in respective ones of the bags. Typically, the present invention can be operated to detect bags which are not properly stacked, or bags which have a deformation like one or more folded corners, sometimes referred to as a “dog ear”. The present invention can be practiced in association with conventionally-operated bag-making equipment, including Hudson-Sharp Machine Co. Model 5750W (European built) and Model 275W (U.S. built).

In accordance with known manufacturing techniques, a series of bags can be manufactured from a web of thermoplastic material, attendant to repetitive making of side weld seams, and pick-up and stacking of the bags. During this process, it is possible for the location of one or more (typically two (2)) of the stacking holes defined by each bag to not properly match up with the associated stacking pins. Thus can undesirably lead to a so-called “one holer”, that is, a bag which is stacked on only one stacking pin, instead of on the two stacking pins that are typically provided.

As noted, another possible defect in connection with stacking of the bags is the formation of a so-called “dog ear”, wherein one or more corners of the bag is folded generally inwardly. This can occur during drawing of the bag, when the drawing of the bag is impeded in such a manner that typically the leading edge of the bag has a folded corner on the lip area of the bag.

Another possible defect in connection with formation of stacks of bags can relate to the faulty location of printing or other graphics on a bag.

Typically, bags produced on this type of manufacturing apparatus are later being filled on automatic filling devices. The speed of these fillers can go up to 120 cycles per minute. In those instances where stacks of bags contain “one holers”, or “dog ears”, this can seriously and inhibit the automatic filling process. Typically, such a defective bag leads to non-filled bags, where the filling product is wasted, and can also lead to disruption and stops in the filling line. Typically, such filling devices are in-line with the manufacturing machine making the product being placed in the bags. In the worse case, defects in the stack of bags can undesirably lead to a complete stop of the manufacturing line.

The present invention has been developed by the recognition that stacks of bags delivered to an automatic filler need to be 100% free of “one holers” or “dog ears”. At present, control in this manner is effected by the machine operator of the wicket machine, that is, the machine which effects bag stacking. Typically, stacks of bags are visually inspected by the operator, and defective or defaulted bags removed. As this depends on the operator's skill and alertness, it can happen that certain bags elude detection, with such bags ending up in the filling machine, and undesirably leading to stops in the filling operation.

Manufacture of bags of the type for which the present inspection system can be operated is typically initiated with unwinding of a layer of flat web film from an associated unwind stand. As will be known by those familiar with the art, the web of film is folded over a folding board, with a gusset applied to the web of film. The web of film then enters the bag-making machine via the infeed section thereof. As noted, a Model 5750W Hudson-Sharp Machine Co. bag-making machine is one type of bag manufacturing apparatus.

During bag formation, the web of film material passes through the intermittently moving portions of the bag-making machine, whereby a number of operations are performed on the film web to manufacture individual ones of the bags. Formation of each bag typically includes formation of a side weld with a side weld sealing head. Picking up and common stacking of the bags is effected in connection with an index conveyor.

More specifically, unwinding of the flat web of film material can be performed in association with an unwind stand, such as Model SDU1600, Hudson-Sharp Machine Co. This type of unwind stand is an electrical surface driven and braked unwind apparatus, with a compensator provided to ensure accurate web control. A web guiding system ensures accurate guiding of the web as it exits the unwind apparatus.

As noted, the layer of web material is folded, with the pre-guided web pulled over the folding board by the infeed section of the associated bag machine. By this operation, the web is formed into a J-folded configuration, wherein the “lip” of each bag being formed is typically 35-45 mm wide. In current practice, a standard Hudson-Sharp Machine Co. Model 1500 mm folding board has been used.

Optionally, a bottom gusset can be formed in the J-shaped web. The gusset former is a standard Hudson-Sharp Machine Co. Model 750 mm gusset former.

The infeed section is the first section of the Model 5750W basic bag-forming machine. The machine pulls the J-folded web into the machine from the gusset former, folding board, and unwind stand by means of a set of nip rolls, typically driven by an AC motor. This AC motor is controlled by a frequency controller which receives speed reference from the main machine controller, and the position feedback signal from the infeed dancer, which is part of the infeed section of the apparatus, and located just downstream of the nip rolls.

Intermittent motion of the bag-making machine is effected by the provision of a servo-motor positioned single roll dancer, and a set of servo-driven nip rolls. In between these two servo-drive arrangements, several attachments typically apply the desired transformations of the web material, such as the punching of wicket holes for stacking, and monitoring with a photo-eye for effecting print registration.

Formation of each bag is done in the sealing section of the Model 5750W bag-making machine. The servo-driven nip rolls “push” the web forward onto a set of driven belts. The bag to be made is introduced onto these belts. Several sets of air jets assist with the development of the bag in order to keep the bag as flat as possible during the formation process.

Typical seals that are formed include side seals. The sealing edge of the side weld seal bar is heated to a preset temperature, and has a certain predetermined radius. The temperature and radius of the sealing edge are selected depending upon the film thickness, and the film composition. The applied heat will separate the web from the drawn bag, and thereby form, that is create, a seal between the different layers of the film.

Picking up and stacking of the bags is next effected, with the inspection system of the present invention located in association with this area of the bag-making machine. Operation of the inspection system will be described in greater detail hereinafter.

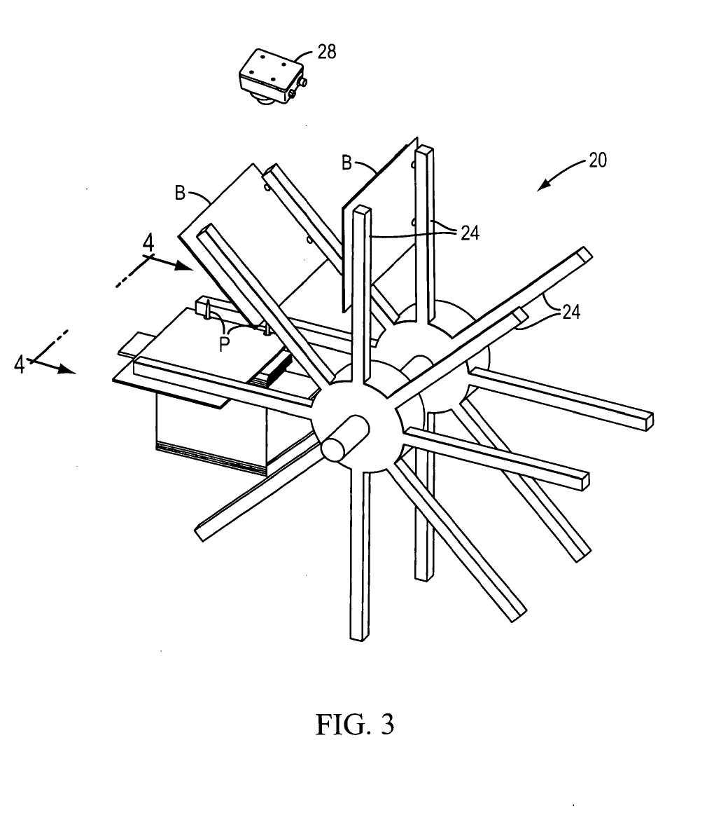

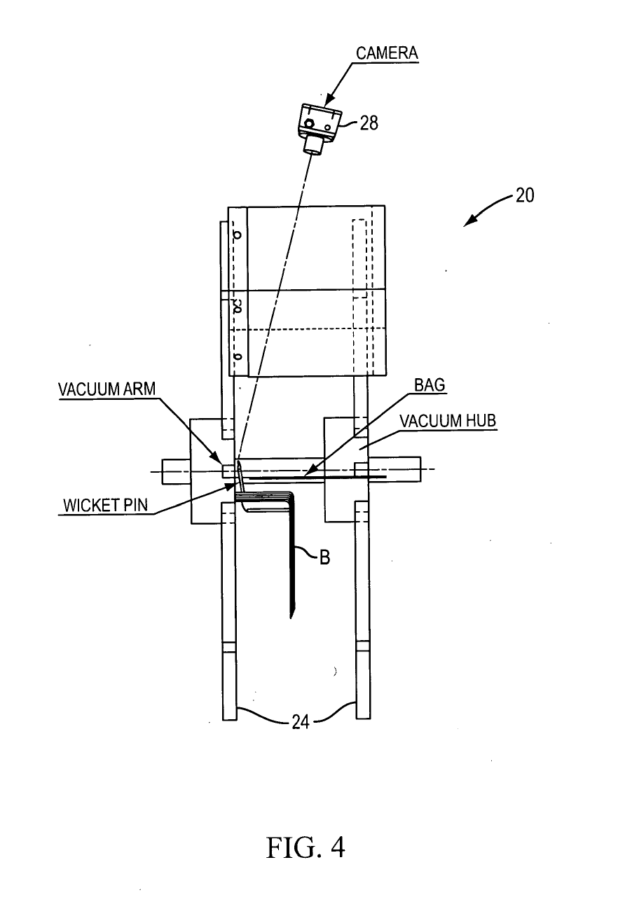

The picking-up and stacking of bags is performed in the pick-up and conveyor section of the Model 5750W bag-making apparatus. A wicket mill, with two or more sets of vacuum-loaded arms, picks up each bag from the belts of the bag-making machine. The vacuum holds each bag against a respective set of the arms of the wicket mill. This is illustrated in FIG. 3, wherein wicket mill 20, including pairs of vacuum-operated arms 24, carries each one of bags B on a respective pair of the arms 24.

After approximately one-half revolution of the wicket mill 20, the stacking holes of each of the bags B are aligned with a pair of staking pins P. As each bag moves over the stacking pins, the vacuum on the arms 24 is discontinued in order to release and stack each bag.

As noted, the present inspection system concerns detecting, and eventually removing, bags determined to have a fault or defect, such as a “dog ear” or a “one holer”. It is within the purview of the present invention that modifications can be made, while keeping with the principles disclosed herein.

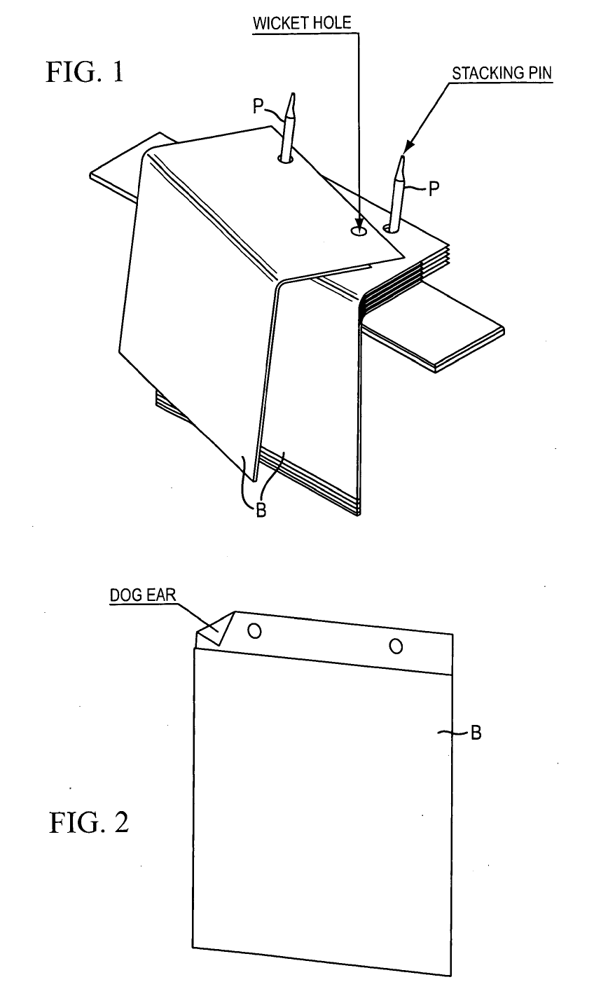

In principle, it is desired to detect defects in a stack of bags which can interfere with proper operation of an automatic filling apparatus, by which the individual bags are filled with associated articles. As noted, such defects include “one holers”, as illustrated diagrammatically in FIG. 1, and “dog ears”, as illustrated diagrammatically in FIG. 2.

Preferably, the moment at which defects such as noted above are detected depends upon the specific type of defect to be identified. However, it is within the purview of the present invention that the specific moment at which a defect is detected can vary while keeping with the principles disclosed herein.

By way of example, “dog ears” can be detected from the moment that the draw of the bag-making machine is on-going, until the bag is placed on the associated stack.

In contrast, the ideal moment to track and identify a “one holer” is the moment that the lip of the bag goes over the associated wicket pins. Only at that moment can it be determined whether each of the holes of the bag has gone over its respective pin. However, it is possible to inspect and determine the position of the hold prior to the bag being placed on the associated pins, and to then make a mathematical tracking calculation of the path of the holes in order to calculate the “landing position”, and whether such a landing position has each of the holes of the bag positioned on its respective stacking pin. However, detecting a “one holer” in this manner is based upon the assumption that the bag does not move on the stacking arms any more after the detection of the hole positions.

Thus, in order to minimize the hardware needed to perform the necessary detections, with consideration of the “ideal moment” theory, it is presently preferred that the moment of detection is when the stacking holes of each bag go over the associated stacking pins.

It is presently preferred that practice of the present invention is effected with use of camera technology to detect the certain defects in the bag stacking operation which are to be identified. A camera detection system can be provided such as by a Banner Model P4-OMNI camera, and Data Sensor Model SCSS1. Other suitable cameras can be employed for practicing the present invention.

Practice of the invention is effected by providing the camera of the system, designated 28, in operative association with the bag-making machine, with the camera positioned and adjusted so that it can make a clear image of the area of the bag that needs to be inspected at the moment defects are to be detected. Sufficient back lighting is provided to ensure clear images.

When the associated bag-making machine is running, the machine provides a feed trigger signal to the camera at the moment that the desired inspection needs to be executed. At this command, the system “will grab” or capture the desired image.

The captured frame, i.e., image, is then mathematically analyzed in the predetermined area at which the defect is to be detected. By way of example, the area for potential “dog ears” can be analyzed for the presence of plastic film material. The position of the center of gravity of the wicket holes can be calculated, and compared to a theoretical ideal position. The “roundness” of the wicket holes can also be calculated, and for example, be expressed in a value between 0 and 1.

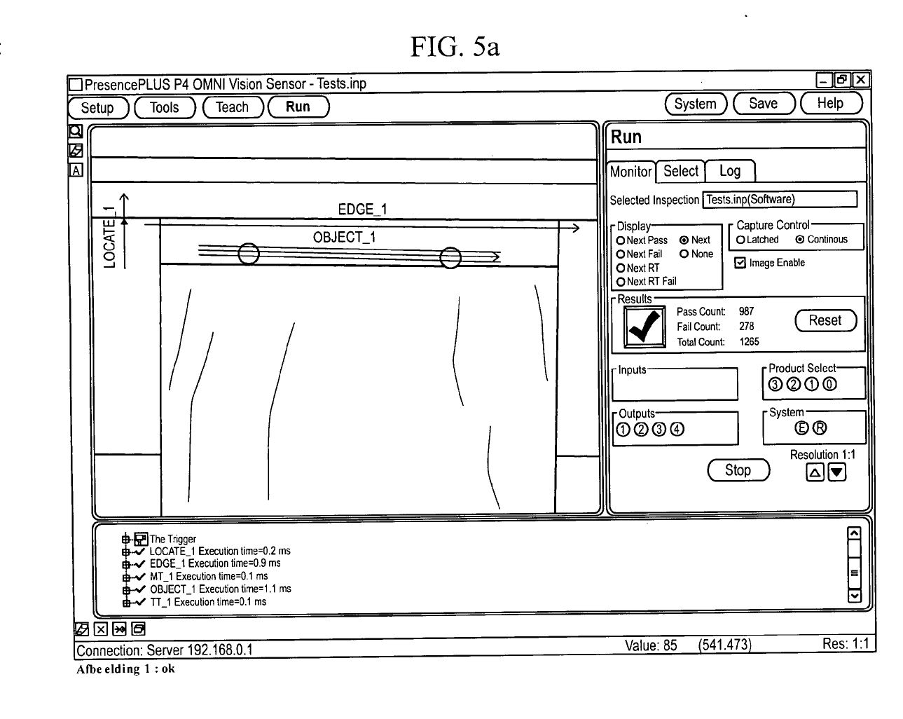

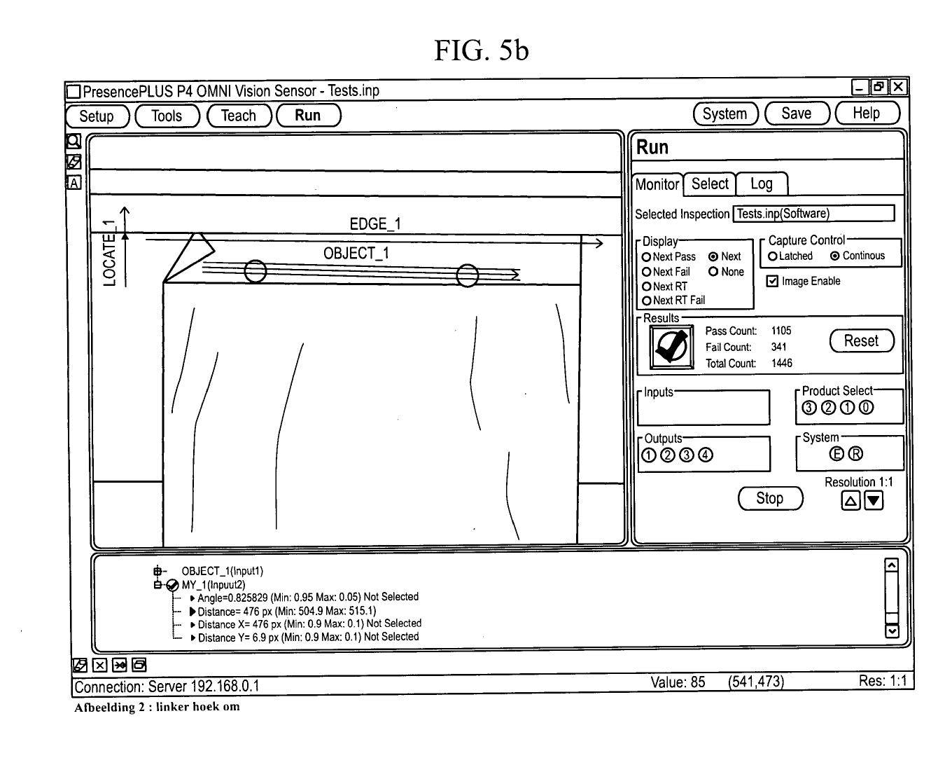

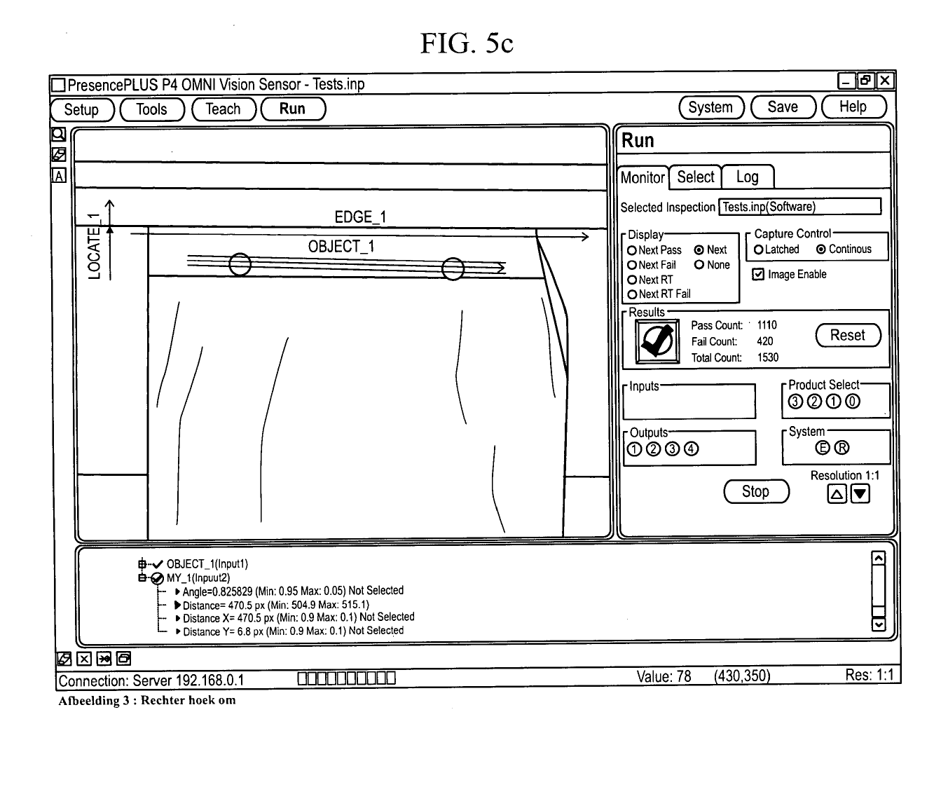

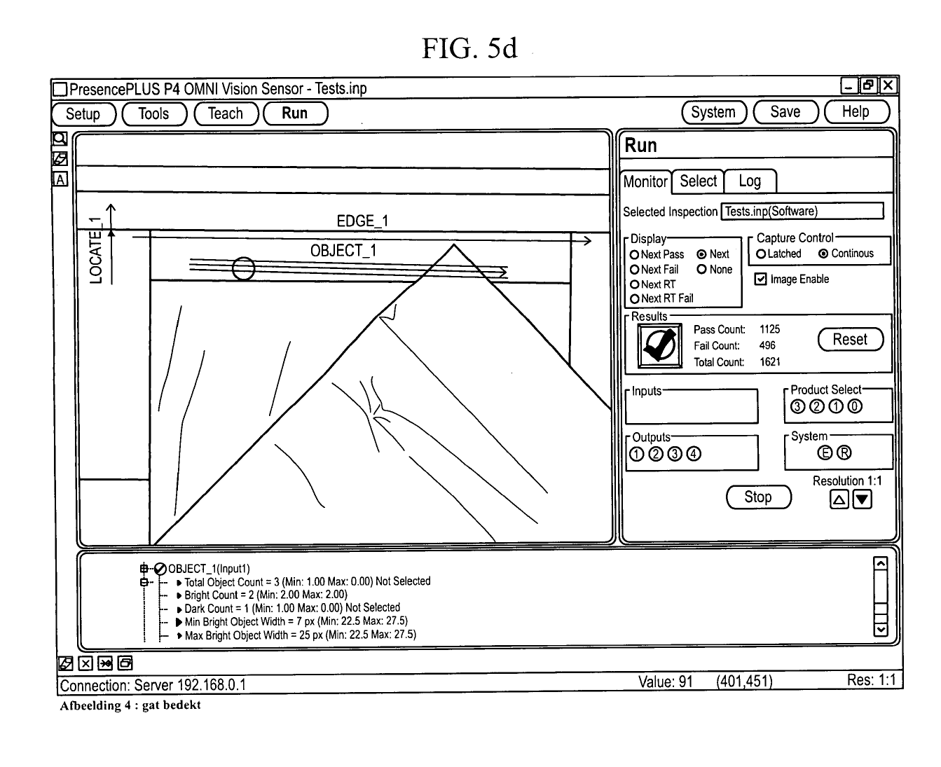

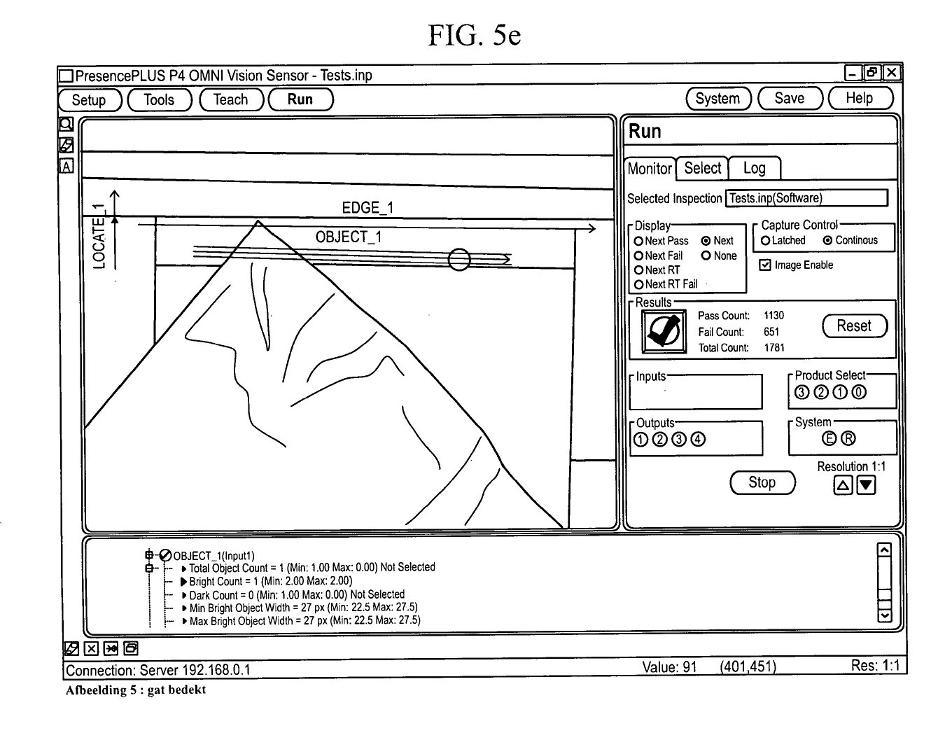

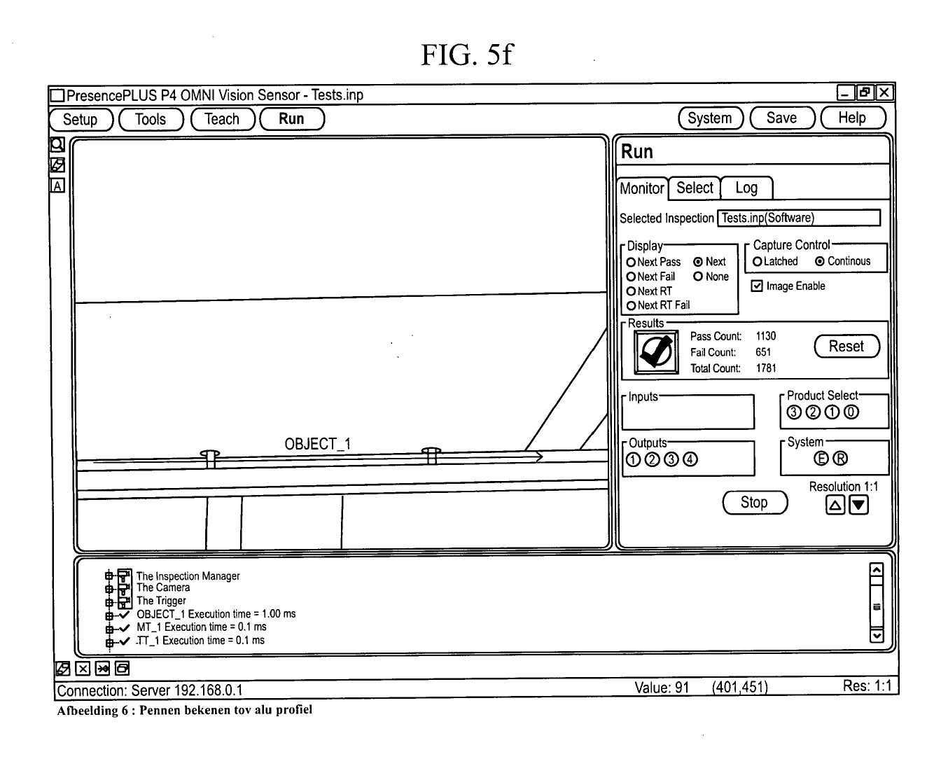

FIGS. 5a-f illustrate the display screen and associated controls of a camera inspection system for practice of the present invention. FIG. 5a illustrates certain parameters of the inspection system which can be employed for practice of the present invention, with the features being inspected associated with the header portion of a bag in which a pair of wicket holes have been formed. FIG. 5a illustrates the position and configuration of the bag which is free from defects.

FIGS. 5b and 5c illustrate, respectively, “dog ears” formed at left-hand and right-hand corners of a bag. Either one of these conditions can be considered as a defect to be detected by the system of the present invention.

Similarly, FIGS. 5d and 5e illustrate “one holer” conditions which are defects which can be detected in accordance with the present invention.

FIG. 5f illustrates orientation of the present inspection system for inspecting the profile of a bag.

Measurements of the images captured by the camera are analyzed by a sequence of logic functions in order to determine whether the particular bag being inspected is acceptable, or rejected. This analysis is done by an appropriate processor, and software present in the current available camera systems. Typically, the processing time of this analysis takes between 10-40 milliseconds, depending on the camera model and the size of the analysis task. With consideration of the current cycle time of a typical wicket machine (by way of example, typically 150 milliseconds at a speed of 400 bags per minute), there is sufficient time for the analysis to be performed. All data is available in the camera, and can be exported for means such as reporting, for example. Typically, the camera system includes communication means, via digital outputs, serial communication, ethernet, etc.

Captured data can be used in a variety of fashions in accordance with the present invention. The data which is obtained from the camera system can be used for warning operators about potential non-conforming products. Similarly, the data can provide an indication of improper settings on the bag-making machine, and provide a measure of the consistency of the process, and can provide process control (SCADA-DATA CAPTURING).

Beyond merely identify potentially non-conforming products, the present system can be operated in conjunction with a suitable mechanism for removing non-conforming products from the product stream. By way of example, a potential method for removing a non-conforming product can include an arrangement such that at the moment of detection, vacuum applied on the lip side of the bag is released, and vacuum on the gusset side of the bag is maintained for a longer period. This will act to drag the bag downwardly, and eventually break the bag top above the wicket hole thereof. Once the bag is near the bottom of the machine, vacuum on the gusset side is released, and the bag can be blown off. A scrap collector can be provided on the bottom of the machine to evacuate the non-conforming bag.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. A method of making and inspecting bags, comprising the steps of:
providing a web of film material;
folding said web of material;
forming a series of bags joined together at edges portions thereof by forming periodic seals in said web of material, and forming a pair of holes in each of said bags;
cutting said web of material at said seals to form individual ones of said bags;
providing a camera for electronically inspecting a portion of each of said bags;
providing signals to said camera in cooperation with said cutting step to form an electronic image of said portion of each of said bags; and
electronically analyzing each said electronic image to evaluate conformance of each electronic image with predetermined parameters.

2. A method in accordance with claim 1, including:
folding said web of material to form a J-shaped cross-section to form each said bag with a header portion, and forming said pair of holes in the header portion of each said bag.

3. A method in accordance with claim 2, including:
forming a gusset in said web of material to form each said bag with a bottom gusset.

4. A method in accordance with claim 1, including:
placing at least one of said holes of each said bag on a leg of an associated wicket during said step of electronically inspecting each said bag.

5. A method in accordance with claim 1, wherein:
said portion of each of said bags is that portion in which the pair of holes is formed.

6. A method in accordance with claim 1, including:
diverting any one of said bags which creates an electronic image that does not conform to said predetermined parameters.

7. A method in accordance with claim 5, wherein:
said analyzing step is performed in conjunction with placement of each bag on an associated pair of wicket pins.

8. A method in accordance with claim 4, wherein:
said analyzing step includes at least one of: (a) identifying a folded corner of a bag; and (b) determining that only one of said holes on a bag has been placed on an associated wicket.
